(19) United States
(12) Patent Application Publication
(10) Pub. No.: US 2014/0359109 A1
(43) Pub. Date: Dec. 4, 2014

(54) DEVICE MONITORING

(71) Applicant: Hewlett-Packard Development Company, L.P., Houston, TX (US)

(72) Inventors: Martin Arlitt, Calgary (CA); Manish Marwah, Palo Alto, CA (US); Geoff M. Lyon, Half Moon Bay, CA (US); Amip J. Shah, Santa Clara, CA (US)

(21) Appl. No.: 13/907,572

(22) Filed: May 31, 2013

(51) Int. Cl. H04L 12/26

(52) U.S. Cl. CPC H04L 43/0876
USPC 709/224

(57) ABSTRACT

Example embodiments relate to device monitoring. In one example implementation according to aspects of the present disclosure, a computing device may include one or more processors, a memory for storing machine readable instructions, and a data store. Additionally, the computing device may include a utility device monitoring module stored in the memory and executing on at least one of the one or more processors to passively monitor network information and power information from a utility device communicatively coupled to a network and a power source.

### BACKGROUND

Utility companies use devices, such as water, gas, and electric meters, to monitor customer utility usage, such as water usage, gas usage, and electricity usage, respectively. The growing economic, environmental, and social concerns over the resource consumption of buildings, campuses, cities, and enterprises is resulting in the deployment of extensive metering infrastructures to provide more detailed consumption information. For example, utility companies have begun using “smart meters” (meters networked together) to collect and transmit data, including utility usage data. Efforts are also underway to extend these infrastructures to control the resource usage, such as through the use of actuators.

### BRIEF DESCRIPTION OF THE DRAWINGS

The following detailed description references the drawings, in which:

FIG. 1 illustrates a computing device having a device monitoring module for monitoring utility devices according to examples of the present disclosure;

FIG. 2 illustrates a system of utility devices and a related computing device for monitoring the utility devices according to examples of the present disclosure; and

FIG. 3 illustrates a method for utility device monitoring according to examples of the present disclosure.

### DETAILED DESCRIPTION

As utility companies have begun using “smart meters” (meters networked together) to collect and transmit data, including utility usage data, and actuators for controlling utility usage, a utility company may desire the ability to manage the smart meter and actuator infrastructure. These utility devices may require both power and network connectivity, in some examples. Moreover, as the number of deployed utility devices grow, it becomes increasingly difficult to manage the utility device infrastructure manually. The time (and consequently, the cost) required to discover issues manually within the utility device infrastructure (such as misconfigured or failed meters and actuators) also increases along with the increase in the size of the infrastructure.

For example, a utility company may wish to monitor the consumption of resources continuously. Monitoring the consumption of resources is especially desirable for utility companies with large numbers of smart meters or when the infrastructure is extended to enable automated control of resources. Moreover, the utility companies may wish to perform various troubleshooting tasks to ensure the smart meters are functioning properly and to detect problems and solve problems. In addition, in some cases the meters and actuators may be installed by a different entity than the entity who manages the infrastructure.

Currently, several “active” techniques may be used to attempt to discover devices on a network. For example, generating various types of network traffic may be useful in identifying or discovering devices on a network. However, these active techniques are unable to discover “stealth” devices (e.g., devices intended to operate without the knowledge of the customer). Additionally, on some networks, active techniques may be unable to discover any devices if the protocols used for discovering devices have been blocked by the network administrator (e.g., for security purposes). Moreover, active techniques increase network traffic and thus are typically not used on a continuous basis. Consequently, new devices or devices with problems may go unnoticed or undetected for quite some time.

Various embodiments will be described below by referring to several examples of device monitoring. For example, the device monitoring described herein may include passive smart meter monitoring, which may enable systematic identification of actionable events concerning the operation of metering and actuation infrastructure using passively collected information or data.

In some implementations, the device monitoring may reduce the number of communication gaps regarding changes to the physical infrastructure of the meters and actuators. Additionally, the device monitoring may also reduce the number of human errors that occur in configuring the infrastructure management system by systematically extracting information, including MAC addresses, from actual network communications (rather than relying on a human to enter the data). Moreover, device monitoring may enable discovery of passive meters (e.g., those with misconfigured or broken network stacks, or “stealth” meters intending to gather usage data without the knowledge of the customer). In this way, meters and actuators may be quickly and automatically detected. These and other advantages will be apparent from the description that follows.

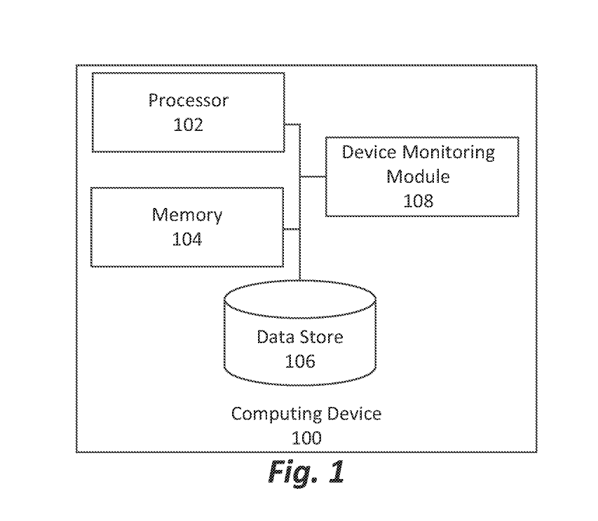

FIG. 1 illustrates a computing device 100 having a device monitoring module 108 for monitoring utility devices according to examples of the present disclosure. The computing device 100 may include a processor 102, a memory 104, a storage device 106, and the device monitoring module 108. It should be understood that the computing device 100 may include any appropriate type of computing device, including for example smartphones, tablets, desktops, laptops, workstations, servers, smart monitors, smart televisions, digital signage, scientific instruments, retail point of sale devices, video walls, imaging devices, peripherals, or the like.

The processor 102 may be configured to process instructions for execution by the computing system 100. The instructions may be stored on a non-transitory tangible computer-readable storage medium, such as in the memory 104 or on a separate device (not shown), or on any other type of volatile or non-volatile memory that stores instructions to cause a programmable processor to perform the techniques described herein. Alternatively or additionally, the example computing system 100 may include dedicated hardware, such as one or more integrated circuits, Application Specific Integrated Circuits (ASICs), Application Specific Special Processors (ASSPs), Field Programmable Gate Arrays (FPGAs), or any combination of the foregoing examples of dedicated hardware, for performing the techniques described herein. In some implementations, multiple processors may be used, as appropriate, along with multiple memories and/or types of memory.

The data store 106 of the example computing system 100 may contain user data and/or an operating system. In one example, the data store 106 may be a hard disk drive or a collection of hard disk drives (or other similar type of storage medium). The data store 106 may be included in the example computing system 100 as shown, or, in another example, the data store 106 may be remote from and communicatively coupled to the computing system 100 such as via a network. The data store 106 may also be a collection of multiple data stores. In one example, the data store 106 may be an entire data store server or a collection of data store servers configured to store large amounts of data.

The device monitoring module 108 may passively monitor a utility device such as a smart meter or actuator or other similar device. In one example, the device monitoring module 108 may be a utility device monitoring module for passively monitoring network information and power information from a device, such as a utility meter or actuator, communicatively coupled to a network and a power source. The device, such as a smart meter or actuator, may transmit both network activity and power activity. Both the network activity and power activity may provide information about the state of the corresponding utility device (e.g., smart meter or actuator). In some examples, it may not be possible to observe all network activity and power activity from each device.

The device monitoring module 108 may analyze both network activity and power activity (together, separately, or one or the other) to determine whether an event has occurred. In one example, this may include observing patterns in the power activity data and/or network activity data to determine whether an expected condition has occurred or whether an anomaly condition has occurred. If an event has occurred, such as the addition of a device, or the detection of a malfunctioning device, data related to the event may be logged in data store 106. In one example, expected conditions and events may also be logged in data store 106.

The device monitoring module 108 may also include sub-modules for performing various discrete tasks. For example, the device monitoring module 108 may include a network traffic aggregator, a network traffic monitor, a power analysis engine, a pattern recognition engine, a diagnosis engine, an event generation engine, and a management console. The function and application of these sub-modules are described in more detail below.

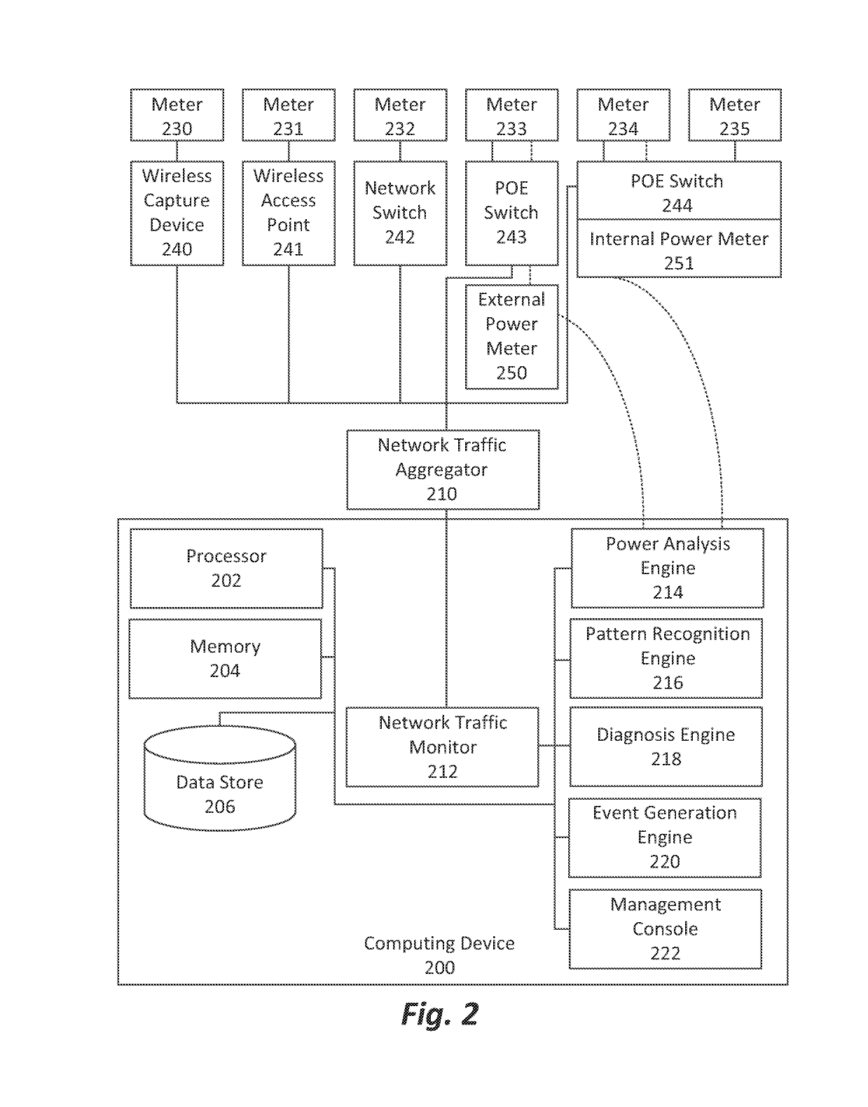

FIG. 2 illustrates a system of utility devices and a related computing device 200 for monitoring the utility devices according to examples of the present disclosure. The system may include devices 230,231,232,233,234,235, which may be, for example, smart meters for collecting utility consumption data, and a computing device 200. In another example, the meters 230,231,232,233,234,235 may include actuators or other types of similar devices.

Meters 230, 231, and 232 may be connected to external power sources (not shown), such as batteries or power/electrical outlets. Meter 230 may communicate wirelessly with an external network device, so a wireless capture device 240 may be utilized to passively observe and monitor the wireless communications transmitted from meter 230. Meter 231 may also utilize wireless communication by transmitting data through a wireless access point 241. In this case, the network data transmitted to the wireless access point 241 may be passively observed and monitored. In one example, the network traffic aggregator 210 may also monitor the network (such as a wired network) to which the access point is connected. Meter 232 may be connected to a network switch 242, such as an Ethernet switch or other similarly appropriate network switch. The network data transmitted to the network switch 242 may also be passively observed and monitored, for example, via port mirroring or via a network tap.

Meters 233, 234, and 235 may be directly connected to a power-over-Ethernet (POE) switch such as POE switch 243 and/or POE switch 244, or the like. These meters may receive power directly from the POE switch 243,244. In this example, the power consumption and network communications of meters 233 and 234 may be observable. The power consumption of meter 235 may be monitored, in one example, but not the network communications because meter 235 is not communicating over its network link.

In one example, if a POE switch includes an internal power monitor with per-network-port power consumption information, then the power consumption information may correspond to the activity of a single meter. However, in other examples, if the switch does not have per-network-port power information, or if an external power monitor is used, or if the link is shared upstream by multiple meters (e.g., via a mini-switch), then it may be necessary to disaggregate the power information to identify the different devices and activities observed.

In the example shown in FIG. 2, the network traffic of meters 230,231,232,233,234,235 may be forwarded to a network traffic aggregator 210. The network traffic aggregator 210 may be a specialized device or may be built into a network switch or router or into a computing device, such as computing device 200. In one example, network traffic aggregator 210 may aggregate network traffic received from the meters to a network traffic monitor 212. The network traffic monitor 212 may de-multiplex the network traffic, extract information about the various communications that have occurred, and then transmit the extracted information to a pattern recognition engine, such as pattern recognition engine 216 of the computing device 200.

In this example, the meters 230,231,232,233,234,235 may be monitored by the computing device 200, which may include various engines and modules for receiving, analyzing, processing, and/or transmitting data received from the meters 230,231,232,233,234,235. In one example, the various engines depicted within computing device 200 may operate on other similarly situated computing devices in any appropriate combinations. The computing device 200 may include, for example, a processor 202, a memory 204, a storage device 206, a network traffic monitor 212, a power analysis engine 214, a pattern recognition engine 216, a diagnosis engine 218, an event generation engine 220, and a management console 222. In one example, the computing device 200 may also include the network traffic aggregator 210. It should be understood that the computing device 200 may include any appropriate type of computing device, including for example smartphones, tablets, desktops, laptops, workstations, servers, smart monitors, smart televisions, digital signage, scientific instruments, retail point of sale devices, video walls, imaging devices, peripherals, or the like.

Once the information is received by the pattern recognition engine 216 of computing device 200, the pattern recognition engine 216 may check for expected and unexpected patterns within the extracted network information (or power information), hi one example, if network communication patterns stop or deviate from an expected pattern (e.g., hourly transfer of data to the management server), an event could be generated indicating a potential problem. In another example, expected patterns may indicate that a new device has been added to the infrastructure. In this case, the pattern recognition engine 216 may detect a signal from a device with a different address than any of the existing devices, thus indicating the addition of a new device.

In the pattern recognition engine 216, both individual time-series and groups of time-series may be monitored, for example. These time series may include attributes from power measurement and network traffic measurement (if available). The individual meter data may be used to detect events related to each respective meter. Similarly, groups of meters can be considered together to detect events that span a wider region, for instance, but may also be detectable by considering each meter individually, in one example.

The pattern recognition engine 216 may utilize one or more analytics techniques for detecting events within the meter power and network data. For example, one method may utilize principal component analysis (PCA) for detecting events. This method of PCA may include tracking the number of principal components of a set of attributes over time and generating an event if this number changes. In another example, entropy-based methods that monitor the information content in multiple time-series over time can be used. By detecting and analyzing both power consumption data and network traffic data, additional events may be detected (e.g., anomalies that may otherwise go undetected if only network data or only power data is monitored).

The resulting patterns, expected and/or unexpected, may be sent to a diagnosis engine 218, which may determine if any activities or patterns show a problem or event requiring action. For example, if a new meter is detected or if an unexpected communication occurs, as detected by the diagnosis engine 218, an event generation engine 220 may generate an actionable event. Similarly, if unexpected communications occur with a meter or actuator, an event could be generated and sent to both the management console 222 and the data store 206. An actionable event may be forwarded to a management console 222, enabling a system administrator to review the actionable event. The administrator may also be able to act on the event if necessary. For example, if a new device is detected as being added to the network (for which the location may be known), the administrator may be prompted to, for example, a) confirm that the new device is an authorized device to add to the network, b) to confirm that information determined about the device is correct, and c) to enter any metadata about the device, such as its role, function, or location. This sort of information may make it easier to audit the devices, as well as to troubleshoot problems that arise over time, for example. In another example, if a device is determined to have stopped working correctly, the administrator may be notified of this, along with an explanation or evidence to support the conclusion. The administrator may use this information in deciding what action to take.

Additionally, in one example, the various types of data from these different steps may be forwarded to a data repository, such as data store 206, such as for security, auditing, and/or troubleshooting purposes. For example, data store 206 may log expected and unexpected patterns as well as any detected events. The saved historical data relating to expected and/or unexpected patterns and detected events may be used to classify new events as expected events or unexpected events. Further, if a new, unexpected event is detected, similar unexpected events may be identified in the history log to assist an administrator with understanding the event.

Additionally, power data received from meters 233, 234, and 235, for example, may be analyzed by a power analysis engine 214. The results of the power analysis engine 214 could be used in conjunction with the network communication information analyzed by the pattern recognition engine 216, diagnosis engine 218, and event generation engine 220 discussed herein. For example, power information may be received by external power meter 250 from meter 233 via POE switch 243. Similarly, power information may be received by internal power meter 251 from meters 234 and 235 via POE switch 244. This power information may be provided to the power analysis engine 214 or the pattern recognition 216 to determine whether an event has occurred.

In one example implementation within a small environment, network communication and power consumption data could be processed by a single monitoring system and set of engines. In another example implementation for larger environments (e.g., a campus, city or enterprise with multiple buildings) the network monitoring, power analysis, pattern recognition, diagnosis, and event generation could be distributed among several systems.

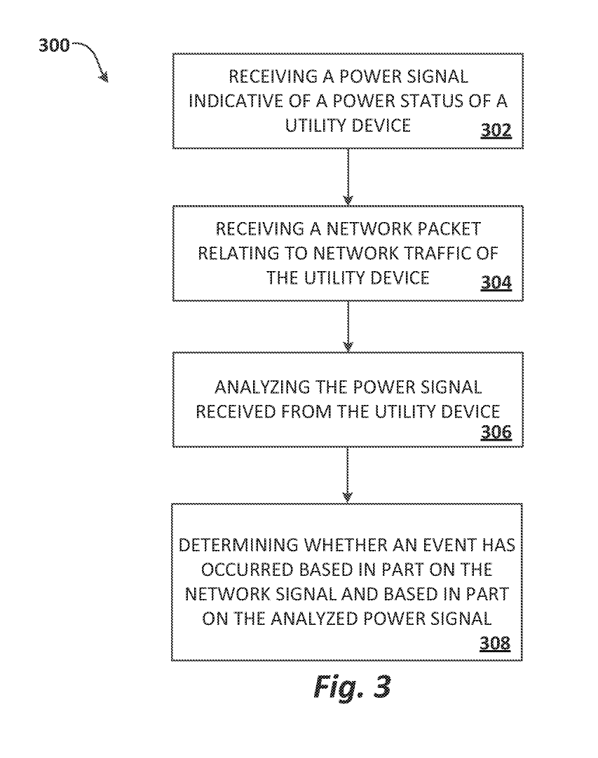

FIG. 3 illustrates a method 300 for utility device monitoring according to examples of the present disclosure. The method may be performed, for example, by the computing devices 100 and 200 shown in FIGS. 1 and 2 respectively, or by another similarly suited device.

The method 300 may include: receiving, from a monitored utility device, a power signal indicative of a power status of the monitored utility device at a power analysis engine (block 302); receiving, from the monitored utility device, a network packet relating to network traffic of the monitored utility device at a network traffic monitor (block 304); analyzing, by the power analysis engine, the power signal received from the monitored utility device (block 306); and determining, by a diagnosis engine, whether an actionable event has occurred based in part on the network signal and based in part on the analyzed power signal (block 308). Additional processes also may be included, and it should be understood that the processes depicted in FIG. 3 represent generalized illustrations, and that other processes may be added or existing processes may be removed, modified, or rearranged without departing from the scope and spirit of the present disclosure.

At block 302, the method 300 may include receiving, from a monitored utility device, a power signal indicative of a power status of the monitored utility device at a power analysis engine. The power status may be a consumption amount, an indication of whether the device is drawing power, or another suitable measure. The power signal may be transmitted by an external power source (e.g., a monitored outlet or battery) or by a powered network link, such as power-over-Ethernet. In these cases, the power signal may be analyzed.

At block 304, the method 300 may include receiving, from the monitored utility device, a network packet relating to network traffic of the monitored utility device at a network traffic monitor. The network packet (or multiple packets) may be transmitted directly to the monitoring system via a wireless or wired network, via a network traffic aggregator, or by other appropriate method. In this way, the network traffic monitor may receive the network traffic being communicated to and from the utility device. Additionally, the network signal may be detected while it is being transmitted to a third-party network.

At block 306, the method 300 may include analyzing, by the power analysis engine, the power signal received from the monitored utility device. The power may be analyzed to determine the amount of power consumption. A change in power consumption, for example, may indicate an event such as the addition of a utility device or an improperly functioning utility device.

At block 308 the method 300 may include determining, by a diagnosis engine, whether an event has occurred based in part on the network signal and based in part on the analyzed power signal. The diagnosis engine may determine if any activities or patterns show a problem or event requiring action. Block 308 may, in one example, include the use of a pattern recognition engine to recognize expected and unexpected patterns in the data. If a new meter is detected or if an unexpected communication occurs, as detected by the diagnosis engine, an event generation engine may generate an actionable event. Similarly, if unexpected communications occur with a meter or actuator, an event could be generated and sent to both a management console and a data store. In one example, an actionable event may be forwarded to the management console, enabling a system administrator to review the actionable event. The administrator may also be able to act on the event if necessary.

In addition, method 300 may include, among other steps, aggregating, by a network traffic aggregator, the network signal received from the monitored utility device and relaying the network signal to the network traffic monitor. The network traffic monitor may de-multiplex the network traffic, extract information about the various communications that have occurred, and then transmit the extracted information to a pattern recognition engine. The pattern recognition engine may determine if an event exists based on the pattern detected from the network signal received from the monitored utility device.

It should be emphasized that the above-described embodiments are merely possible examples of implementations, set forth for a clear understanding of the principles of the present disclosure. Many variations and modifications may be made to the above-described examples without departing substantially from the spirit and principles of the present disclosure. Further, the scope of the present disclosure is intended to cover any and all appropriate combinations and sub-combinations of all elements, features, and aspects discussed above. All such appropriate modifications and variations are intended to be included within the scope of the present disclosure, and all possible claims to individual aspects or combinations of elements or steps are intended to be supported by the present disclosure.

What is claimed is:

1. A method comprising:
receiving, from a monitored device, a power signal indicative of a power status of the monitored device at a power analysis engine;
receiving, from the monitored device, a network packet relating to network traffic of the monitored device at a network traffic monitor;
analyzing, by the analysis engine, the signal received from the monitored device; and
determining, by a diagnosis engine, whether an event has occurred based in part on the network packet and based in part on the analyzed signal.

2. The method of claim 1, further comprising:
in response to determining that an event has occurred with the device, generating an alert by an event generation engine.

3. The method of claim 2, wherein the alert is an actionable event transmitted to a management console.

4. The method of claim 3, wherein the management console enables an administrator to act on the actionable event.

5. The method of claim 1, further comprising:
in response to determining that an event has not occurred with the device, indicating that the device is functioning normally.

6. The method of claim 1, wherein determining, by the diagnosis engine, whether an event has occurred based in part on the network signal and based on the analyzed signal further comprises determining, by a pattern recognition engine, whether an event exists based on a pattern detected from the network signal received from the monitored device.

7. The method of claim 1, wherein data relating to the event is stored to a data storage device.

8. The method of claim 1, further comprising:
aggregating, by a network traffic aggregator, the network signal received from the monitored device and relaying the network signal to the network traffic monitor.

9. A computing device comprising:
one or more processors;
a memory for storing machine readable instructions;
a data store; and
a device monitoring module stored in the memory and executing on at least one of the one or more processors to passively monitor at least one of network traffic and device information from a device communicatively coupled to a network.

10. The computing device of claim 9, wherein the device monitoring module further comprises:
a network traffic monitor stored in the memory and executing on at least one of the one or more processors for receiving aggregated network traffic from a network traffic aggregator, de-multiplexing the network traffic received from the device, and extracting information from the network traffic.

11. The computing device of claim 10, wherein the device monitoring module further comprises:
a power analysis engine stored in the memory and executing on at least one of the one or more processors for analyzing data received from the device.

12. The computing device of claim 11, wherein the device monitoring module further comprises:
a pattern recognition engine stored in the memory and executing on at least one of the one or more processors for analyzing the received extracted information from the network traffic monitor by analyzing patterns within the network data.
a diagnosis engine stored in the memory and executing on at least one of the one or more processors to determine whether an event has occurred regarding the device; and
an event generation engine stored in the memory and executing on at least one of the one or more processors to generate an actionable event.

13. The computing device of claim 12, wherein the device monitoring module further comprises:
a management console stored in the memory and executing on at least one of the one or more processors for receiving the actionable event, wherein the management console enables an administrator to act on the actionable event.

14. A system comprising:
a utility device communicatively coupled to a network and a power source; and
a computing device comprising:
one or more processors;
a memory for storing machine readable instructions; and
a utility device monitoring module stored in the memory and executing on at least one of the one or more processors to passively monitor the utility device, wherein passively monitoring the utility device includes monitoring network traffic received from the utility device.

15. The system of claim 14, wherein passively monitoring the utility device further includes analyzing power information received from the utility device.
